(19) United States
(12) Patent Application Publication
(10) Pub. No.: US 2004/0033291 A1
(43) Pub. Date: Feb. 19, 2004

(54) Starter concentrate for yeast-leavened baked goods

(75) Inventors: Rene Burgermeister, Stettfurt (CH); Bruno Zehnder, Wilen b. Will (CH); Meiert J. Grootes, Hagendorn (CH)

Correspondence Address: HESLIN ROTHENBERG FARLEY & MESITI PC, 5 COLUMBIA CIRCLE, ALBANY, NY, 12203, US

(73) Assignee: VERIPAN AG, Matzingen (CH)

(21) Appl. No.: 10/321,710

(22) Filed: Dec. 17, 2002

(30) Foreign Application Priority Data
May 28, 2002 (CH) CH 2002 0892/02
Jul. 9, 2002 (CH) CH 2002 1207/02

(51) Int. Cl. A23L 1/28

(52) U.S. Cl. 426/62

(57) ABSTRACT

The invention relates to a starter concentrate for producing baked g a method for producing a starter concentrate and the use of said starter concentrate for producing baked goods as well as the baked goods produced with a starter concentrate of this type. For a variety of reasons there is a need to have a suitable alternative both for baking additives and for starter. The starter concentrate taught by this invention is based on mechanically, thermally, thermally-pneumatically and/or mechanically-thermally modified food-grade cereal bran or parts thereof, optionally supplemented by yeast and antioxidants. The starter concentrate is characterized by very good processing characteristics (sort dough ring time), improvement of its baking characteristics (fast and strong oven spring, good baking volume, attractive crust coloration), improved sensory qualities (aroma, taste, mouth feel) as well as a longer shelf life.

This invention relates to a starter concentrate for producing wholly or partly yeast-raised baked goods as described in the introduction to claim 1 and a starter, a procedure for producing the starter as described in the introduction to claim 16 as well as the use of this starter for producing baked goods as disclosed in claim 26 and a finished dough or finished baked goods that are produced with such a starter concentrate as described in the introduction to claims 21 and 23.

Highly leavened breads with a light and porous crumb, as they are generally familiar today, originated only in the eighteenth and nineteenth centuries. Using yeast, which was discovered approximately 150 years ago in Vienna, a sponge or starter dough was Ar that was generally fermented at room temperate overnight in special containers. The yeast, which at the time was a rather weak leave agent, thereby multiplied and the performance of the yeast improved. In quantitative terms the sponge makes up approximately about 25-40% of the total dough.

The sponge generally has the following functions:

Formation of lactic and acetic acids for gluten stabilization, to improve the

Reproduction of the yeast, freshness of the bread and to protect against filamentous bacteria,

Enabling better water uptake through pre-swelling and opening up of gluten-forming proteins,

Formation of precursors of bread aromatics through enzymatic breakdown of proteins, fats and starch.

Even at the time, this method was used to produce voluminous, aromatic breads that would keep for several days.

The era of baking additives began in the 1950s with industrialization. Initially, pure malt products and acids, e.g., vinegar, were used. They were used to improve poor-quality wheat and rye flours and were added directly to the main dough. In the early 1970s, bakeries gradually converted to direct dough production, i.e., without a starter or sponge, for reasons of organization and capacity. This step from the indirect raising of the dough to the direct raising of the dough could not have been achieved without adding baking additives. The additives required for this purpose mostly consisted of malt products, often supplemented by acids, (e.g., citric acid (E330), ascorbic acid 300), calcium phosphates (E341) as well as lecithin (E322) as an emulsifier. Modem baking additives still have roughly the same composition stead of malt products and lecithin, a combination of enzymes produced by biotechnological methods, swelling agents su as “swelling” wheat flour (Quellmehl), guar seed flour and/or emulsifiers such as diacetyl tartaric acid ester, distilled monoglycerides (E471) etc. are used.

Scandals in the food are increasingly causing consumers to seek more natural products. The growth in sales of organic products in recent years attests to this trend. In particular, wishes are being expressed that everyday foods such as bread be made without additives. Not only the dust that is formed during use (allergies) but also the many undesirable additives that are often considered health hazards have resulted in increasing reaction of these products.

One of the few possibilities for making bread without baking additives was the traditional sponge or starter method. Basically, using a sponge or starter has advantages over baking additives in terms of flavor, aroma, crumb consistency and freshness.

There is one method of manufacturing a starter or sponge (using flour ingredients) with and without adding yeast to the sponge production. The method with added yeast is currently the most popular because the alternative without adding yeast, e.g., the preparation of a sourdough “mother,” is significantly more expensive and time-consuming.

Despite these advantages, the use of starters and sponges in both bakeshop and industrial operations is still limited. This is primarily due to the preconditions that must be present for optimal starter production: a stable microflora in the starter (only in the “mother”), a. consistent quality of crude materials (especially of the flour—enzymatic activity, ash content etc.), accurate monitoring of the fermentation parameters (such as temperature, time), strict control of hygiene, permanent analysis of pH, acidity and aroma, well trained personnel, extremely precise production planning (no flexibility), and, in industrial operations, high investment costs. Also, it must be taken into account that the required amount of starter makes up 25-40% of the total dough and, therefore, even in a small bakery, large amounts of starter are required. An uncontrolled fermentation results in an uneven quality of baked goods, undesirable aftertastes, lower bread volume and possibly even a severe over-acidification of the bread. In practice it has also been found that doughs and baked goods produced with a starter did not always exhibit all the desirable properties when contrasted to a dough with additives. If that is the case, the amount of additives can only be reduced but not eliminated.

For the above reasons there is a need to look for a suitable alternative for both baking additives and for the starter used in the prior art. Therefore, one object of this invention is to make available a composition that avoids the aforementioned disadvantages of both baking additives and conventional starters for the production of baked goods. An additional object of the invention is to make available advantageous applications of the composition taught by the invention for the production of baked goods.

With a view to its use in bakeries, the composition in the form of the starter concentrate taught by the invention should be usable in small low doses (3% to a maximum of 5% but preferably 4% for a paste, and 6% to a maximum of 10% but preferably 8% for a suspension, relative to the total amount of flour in the final product), be easy to handle and, last but not least, have a sufficiently long shelf life. Furthermore, acceptance of the starter concentrate should be enhanced by very good processing properties (srt dough ripening period), an improvement of its baking characteristics (faster and better rising in the oven, larger baking volume, beautiful crust coloration), an improvement of the sensory properties (smell, taste, mouth feel) and longer freshness.

Finally, a broad area of application, especially for the production of baked goods, i.e., in a wide variety of recipes with different types and qualities of flour to be added, is desirable. This characteristic can be achieved by an enhancement of the taste of the specific variety of bread; for ample, in a rustic brown bread such as Ruchbrot, the typical flavor of a rustic brown bread will be enhanced, while in white bread, the white bread flavor will be enhanced.

The combination taught by the invention, particularly in the form of a starter concentrate, is based on a cereal bran ingredient. This ingredient is a grain mill by-product. In the production of flour, large quantities of bran are produced that cannot be satisfactorily used for commercial purposes. The nutritional and physiological benefits of bran are well known and generally acknowledged, but it enjoys little popularity in larger quantities because of its taste. Cereal bran(for food) consists of the outer layers of the grain (in particular the cellulose-containing seed coat, the protein- and fat-containing aleuron layer and the germ (contains fats, proteins, vitamins A, B, E etc.), whereby the husks of husked gins are not counted as part of the outer layers. Typically, the raw bran (including the raw bran used in the composition taught by the invention)—depending on the milling procedure—contains 5 to 25 parts by weight, preferably between 7 and 20 parts by weight cellulose, between 10 and 20 parts by weight crude protein, between 1 and 10 parts by weight crude fat, between 10 and 20 parts by weight starch, between 5 and 20 parts by weight crude fiber, and water and crude ash as the remaining ingredients and negligible quantities of secondary ingredients, (e.g., vitamins (e.g., B1, B2, B6, folic acid), metal salts (e.g., iron, zinc, magnesium, calcium, amino acids (e.g., lysine)). These proportions can be calculated according to nutritive value tables (Souci, Fachmann, Kraut, 1989).

Typically, preferred food-grade cereal bran (after extraction of 20 to 35% aleuron) has—again depending on the milling process—the following composition: 1 to 25 parts by weight, preferably 7 to 20 parts by weight cellulose, 10 to 25 parts by weight crude protein, 1 to 10 parts by weight crude fit, 3 to 20 parts by weight starch, 5 to 20 parts by weight crude fiber, with water and crude ash as the remaining ingredients as well as small amounts of secondary ingredients (e.g., vitamins (e.g., B1, B2, B6, folic acid), metal salts (e.g., iron, zinc, magnesium, calcium, amino acids (e.g., lysine)). These proportions can be calculated according to nutritive value tables (Souci, Fachmann, Kraut, 1989).

The invention teaches that preference is given to the use of grin that has been particularly well cleaned before milling for the production of food bran. The term “raw bran” as used here means food-grade cereal bran (i.e., the by-product of flour production in the mill), which includes bran and mixtures of bran of the most important types of grin e.g., wheat or bread wheat (Triticum aestivum=T. vulgare), hard wheat or durum (T. turgidum),einkorn, spelt, emmer, barley, rye, oats, rice, millet, corn and also triticale (a wheat/rye cross) and sorghum. The invention teaches that a distinction must be made between raw bran and processed forms of raw bran (as defined above, a di by-product of the milling operation). Below, these ingredients are designated “processed bra” (after the first processing step) and “processed bran to which water has been added” (after the second processing step).

There are several options for making raw (food-grade) cereal bran available for use in the composition taught by the invention (or the starter concentrate taught by the invention) by means of further processing. These include in particular a mechanical modification of the raw bran obtained during milling, a thermal modification, preferably by means of thermo-pneumatic treatment, and finally, for example, a mechanical-thermal modification by extrusion. Such bran that has ben mechanically, thermally or mechanically-thermally modified as taught by the invention is designated “processed bran” in the context of this invention. The processed bran obtained in this manner can be used to extend the shelf life and to enhance the mouth feel, taste and aroma of food bran.

In fine grinding, which is probably simplest form of modifying raw bran for use as taught by the invention (and, therefore, to get “processed bran”), the raw bran is either first stabilized or finely ground immediately after milling under a cover gas using a classifier mill (e.g., a Netzsch-Condux CSM). This classifier mill combines an impact crusher with an integrated dynamic air separation system (rotor wheel) that makes possible final sizes of <10 μm. Typically, product temperatures of 50 to 70° C. are achieved in this

A thermal modification of raw bran by, e.g., thermo-pneumatic treatment can be performed, for example, by a thermo-pneumatic system of the type that is familiar in milling. These systems consist of fins, heat exchangers and a system of tubes..

In the thermo-pneumatic treatment the raw bran is transported directly from the mill in a system of tubes using hot air (temperature: 100 to 120° C.) for a maximum of 20 seconds. The system of tubes generally has a large diameter (approximately 30 cm) so that a small amount of bran is heated sufficiently quickly. Typically, the bran reaches a temper are of 70 to 80° C. in this process. The initial moire content of the raw bran that will be posed (as the initial product) of 14%, for example, will be reduced to 8%, for example, in the modified “processed (food-grade) cereal bran” as taught by the invention After the “heat line” the bran is usually cooled from 70-80° C. to room temperature using room-temperature air.

In the mechanical-thermal treatment the raw bran is processed directly at the mill, for example, by means of a two-roller extruder manufactured by Bühler-Uzwil. In one advantageous version the roller length is 1.50 m and the diameter 93 mm. Approximately 15-16% water is added in the first quarter of the extruder. Inside the extruder the raw bran is thermally (extrusion temperature about 150° C.) and mechanically processed (maximum screw speed is 450 revolutions per minute). Since preferably only 50-60% of the maximum speed will be used, mechanical processing can be described as rather gentle. A beret with 24 holes of 6 mm diameter each is located at the end of the extruder. Since a relatively low speed is used and the holes are rather large, a relatively low pressure of a maximum of 5 bar accumulates inside the extruder. The hold time in the extruder, given these variables, is about 5 seconds The extruded bran (the extrudate) leaves the extruder in strands of a pasty consistency. Regardless of the extruding conditions, the extruded wheat bran expands only by a little. By cutting the extruded strands directly at the spinneret, a sort of bran paste cube is formed. They are vacuumed up, dried at approximately 140° C. and finely ground by means of a hammer mill.

In WO 02/15711 another procedure for modifying raw bran, especially wheat bran, is described that can also be used in the context of this invention and in which the primary aleuron-containing components in the raw bran are separated from those primarily not containing aleuron. In that respect the fill content of WO 02/15711 is part of this disclosure. The separation can be accomplished by biochemical-enzymatic and/or mechanical abrasive means. In the conventional separation of flour bodies and coats in milling, the aleuron layer remains with the inner and outer seed coats. The bran component is used as food-grade bran for human consumption or as animal food. If the aleuron layer, as disclosed in WO 02/15711, is separated from the seed coat, a residual bran with reduced vitamin, mineral, crude fat and crude protein content but increased fiber and starch content results. Depending on the aleuron yield, the residual bran may have 20% less protein and 50% less minerals. The particle size of the mechanically or mechanically-thermally modified residual bran particles is preferably 200-800 μm and particular preference is given to a size of approximately 300 μm. It is advantageous if the mechanical action on the raw bran is primarily applied in the form of shear forces. This can be achieved, for example, by conducting the fluid with the bran into a colloid mill that then applies the forces. Mechanical-thermal modification can be performed using an extruder. It has been demonstrated that the modified aleuron-reduced processed bran can be used advantageously in a combination taught by the invention (especially in the starter concentrate taught by the invention).

Processed bran modified in this manner can be used in particular in the starter concentrate taught by the invention For this purpose it is essentially desirable that te mechanical, thermal or mechanical-thermal treatment of raw bran (with the object of obtaining processed bran) be performed within 24 h, although greater preference is given to treatment within 10 h, even greater preference to treatment within 3 h and the maximum preference to treatment within 1 h, after obtaining the raw bran (in the course of flour production in the mill).

The starter concentrate, in particular for producing wholly or partly yeast-raised baked goods, therefore typically includes mechanically, thermo-pneumatically and/or mechanically-thermally modified food-grade raw cereal bran (this modification and processing results in “processed food-grade cereal bran” as the product) or parts thereof as well as, optionally, other enhancers and additives, preferably while adding water, optionally yeast and optionally at least one antioxidant.

Typically, after the mechanical, thermal or mechanical-thermal processing step, water is added to the resulting “processed bran” This yields “processed bran to which water has been added” as taught by the invention. The parts by weight of “processed bran” and water can be freely selected depending on the desired consistency of the “processed bran to which water has been added” Typically, the amount of water is >50 parts by weight (corresponding to “processed bran”<50), although greater preference is given to >60 (corresponding to “processed bran”<40), and even greater preference to >65 (corresponding to “processed bran”<35). If required, the water can be added as early as during the thermal, mechanical or mechanical-thermal treatment of the raw bran. In particular, in case of treatment by extrusion it may be advantageous to add water during the extrusion.

The “processed bran to which water has been added” and which has been modified in this manner may now, for example, (i) have yeast added (sew respective disclosure) or, alteratively, (ii) be stored under stable conditions without a defined addition of yeast

This “processed bran to which water has been added” according to (ii) above but without a defined addition of yeast can be stored for up to 6 months. The preferred storage period is 5 to 30 days, but 15 to 25 days is more preferred. Storage should be under aerobic conditions, e.g. in contact with air. The incorporation of wild airborne yeast into the stored “processed bran to which water has been added” is also preferred. Typically, the basic starter is obtained in this manner from the “processed bran to which water has been

Added.” After the expiration of the storage period, this basic starter can again be mixed in with extruded bran, for example, with extruded wheat br The invention teaches that eventually, a starter concentrate as taught by the invention will be or can be obtained

Therefore, in one preferred embodiment of this invention, the “processed food-grade cereal bran” contained in the starter concentrate is extrude& Even greater preference is given to the extrusion of the raw bran from which the “processed food-grade cereal bran” is produced at 130180° C. and preferably at 150° C.

In the preferred case of the use of raw wheat bran, the particles after modification, and in particular after extrusion, have particle sizes of less than 315 μm. preferably with a particle size distribution of at least 95%<200 μm, at least 73%<125 μm, at least.54%<90 μm and at least 22%<63 μm. Starter concentrates that are based on “processed wheat bran” according to the invention are particularly suited for the production of dark dough. In the likewise preferred case of the use of modified and in particular extruded raw hard wheat bran “processed hard wheat bran” as the product) particle sizes of less than 315 μm, preferably with a particle size distribution of at least 82%<200 μm, at least 55%<125 μm, at least 39%<90 μm, and at least 21%<63 μm are preferred. This preferred processed raw bran according to the invention can be used in such sr concentrates taught by the invention as are suitable in particular for the production of light or dark dough. Finally, such starter concentrates are preferred that have modified “Processed hard wheat bran” with particle sizes of less than 315 μm, preferably with a particle size distribution of at least 72%<200 μm, at least 45%<125 μm, at least 29%<90 μm an at least 11%<63 μm, likewise for use in the production of light and dark dough.

The starter concentrate is preferably in the form of a paste (i.e. in paste form) or in the form of a liquid product. Typical starter concentrates as taught by the invention are distinguished by the percentage (proportion) by weight of modified “processed food-grade cereal bran” in the starter concentrate between 6 and 50%, preferably 20 to 40%, with even greater preference for 30 to 40% for a paste-form starter concentrate and 20 to 25% for a starter suspension. Even greater preference is given to starter concentrates whose percentage by weight of “modified processed food-grade cereal bran” in the starter concentrate is 35% for a paste-form starter concentrate and 23% for a starter suspension.

The dosing of the starter concentrate is only about 1/6 to 1/7 of the amount of starter used in the prior art. This advantageous low dose is achieved by increasing the proportion of the ingredients that are important to the fermentation during the later steps of baked goods production although, advantageously, they do not need to be added separately. Their functions are described below:

Grain fibers first, they maintain an optimal water content for the fib and, second, they preserve the fist of the product.

Grain fats: these substances, which are partly broken down during the fermentation, are precursors in the formation of aroma and taste in the baked goods.

Grain starches and carbohydrates: te support an optimal fermentation process in starer concentrates and supply nutrition for the yeast in the main dough The carbohydrates in particular provide good coloration, crust aroma formation and freshness of the pastry.

Grain proteins: these proteins, which are also partly broken down during the fermentation, are precursors in the formation of aroma and taste in baked goods.

Grain minerals: the functional properties come into effect, especially in starter concentrates for dark breads, by enhancing te typical scent and flavor of a rustic country bread.

Nevertheless, other adjuvants and additives may optionally be added to thc starter concentrate. In particular, antioxidants must be mentioned that can protect the starter concentrate, for example, from turning rancid or the formation of undesirable aromatic substances, and consequently improve shelf life. Examples of antioxidants (either alone or in combination) include ascorbic, lactic, tic and citric acid as well as their salts. But the essences of citrus fruits ad, for example, fruit concentrates may be used for this purpose, in particular fruit extracts containing ascorbic acid. By adding antioxidants to the starter concentrate, a natural protection against oxidation is achieved that ensures several days of shelf life for the cooled, fermented paste. The antioxidants simultaneously activate, stabilize and protect the gluten during the rising of the main dough. It will be obvious to a technician skilled in the art that in this case the term does not just include synthetic antioxidants but also naturally occurring antioxidant ingredients, such as acerola powder. All further quantitative statements refer to ascorbic acid as a pure substance.

In the context of this invention, preference is given to starter concentrates that include an antioxidant or ascorbic acid and/or a solution that contains an ascorbic acid as an antioxidant.

Furthermore, in one preferred embodiment, dough-volumizing agents can be added to the starter concentrate, e.g., yeast (in the form of a biological dough-volumizing agent), especially for top-fermenting bread yeasts and in particular baker's yeast or Saccharomyces cerevisiae. The baker's yeast may be compressed yeast (water content approximately 70%) or in the form of dry yeast (water content 8-12%). Finally, both wild yeast (in particular from the air) and yeast extracts (e.g., compressed yeast extracts) can be used. In one preferred embodiment, the starter concentrate, if it contains yeast/yeast components, can contain such parts by weight in a quantity so that no additional yeast needs to be added prior to the baking process. Alteratively, a certain percentage (of the final amount of yeast in the baking mixture) of yeast may be contained in the starter concentrate, typically between 20 and 70%, but with particular prefer to 20 to 50% of the,yeast in the final baling mixture. In one preferred embodiment, the concentration of yeast in the starter concentrate is less than 50 parts by weight, preferably less than 40, more preferably less than 30, and even more preferably less than 20 and most preferably of all between 10 and 20 parts by weight.

If necessary, the starter concentrate can be physically treated to volumize the dough.

The additional or auxiliary ingredients permissible under the food laws (food additives) that a starter concentrate as taught by the invention can contain, include all food colorings, preservatives, emulsifiers, emulsifying salts, thickening agents, stabilizing agents, flavor-enhancing substance acidifiers, acid regulators, modified starches, sweeteners, ring agents, binding agents, glut, in particular wheat gluten, enzymes (in particular acetolactate-decarboxylase-amylase, catalase, pyruvate decarboxylase, chymosin, glucanase, glonotransferase, glucose isomerase, glucose oxidase, bemicellulase), fillers and/or vitamins. Instead of or in addition to tee substances listed above, ingredients that contain enzymes, such as honey, malt flour or malt extract (also in the form of baking additives) may be used instead of te eves or in combination with one or more enzymes in the starter concentrate or can be added to it

The result is a starter concentrate that is a replacement product for the starter known from the prior art with—depending on the criteria—similar, equal or better functional properties in the form of a good starter made of dark, white or combined dark and white flours. The starter concentrate also differs markedly from the baking additives available on the market because of its bioactivity.

The field of use of a starter concentrate that is combined with a main dough in the production of yeast-raised baked goods is primarily in the production of light or dark breads, buns, pizza and pastries. The main dough may contain grain flours of a wide variety of types and degrees of milling, e.g., flours of wheat or bread wheat (Triticum aestivum 32 T. vulgare), hard wheat (T. turgidum, durum), einkorn, spelt, emmer, barley, rye, oats, rice, millet or corn but also triticale (a cross of wheat and rye) or sorghum. However, the min dough may also be made of flour mix , especially mixtures tat contain wheat flours.

In the following essentially three different starter concentrate types will be discussed

“dark” for all dak types of baked goods such as whole grain bread, dark “rustic” loaves, dark ciabatta etc.

“light” for all light types of baked goods such as white bread, partial white bread, baguettes, buns, braided wares, rolls, croissants, pizza, light ciabatta, cake batter with a fat component etc. and

“aleuron-reduced” for all of the above baked good types,

whereby the light and aleuron-reduced type can also be used in the production of the dark baked goods.

All starter concentrates that contain modified proceed food-grade cereal bran, i.e., essentially residual bran with a reduced aleuron component or which are aleuron-free, are also preferred Also preferred are starter concentrates that are reduced in the aleuron component (at least by 20%, preferably by at least 50%, more preferably by at least 70% and most preferably by at least 85% of the aleuron component) or (essentially) aleuron-fie and whose proportion by weight of modified processed food-grade cereal bran is 4 to 30%, and preferably 10 to 20% for a paste-form starter concentrate or 5 to 15% for a starter suspension. Even greater preference is given to starter concentrates when the proportion by weight of modified “processed food-grade cereal bran” in the starter concentrate is approximately 15% for a paste-form starter concentrate and approximately 10% for a starter suspension.

The starter concentrate can be used for wholly or partly yeast-raised baked goods. I the production of baked goods that contain a large amount of rye (>66% rye flour), an acidification agent is added to the main dough to ensure proper baking characteristics. Generally, with the use of the new starter concentrate all the basic recipes can be maintained for all yeast-raised baked goods (e.g., goods that are produced using baking additives). However, attention must be paid to the following requirements:

The baking additive must be replaced by the recommended amount of starter concentrate,

If the baking additive, apart from the baking-promoting substances, also contains other additives required by the recipe such as powdered milk fats, sugar, etc. they must be added in the required amounts,

The amount of yeas must be reduced by 10 to 30% if nothing has changed in the process parameters,

The consistency of the dough can be adjusted by changing the amount of water added. This step is only necessary when replacing baking additives with swelling ingredients such as guar and swelling flour (Quellmehl).

The replacement of all the baking additives with the starts concentrate claimed by the invention makes it possible to comply with the strictest guidelines for organic and/or ecological foods. If the replacement of all the baking additives is not required, the starter concentrate can also be used with small amounts of baking additives.

The starter concentrate taught by the invention is suitable for all known dough rising and baling systems such as the delayed and interrupted techniques, the PATT¹ system and all pre-baking. cooling and deep freezing systems. ¹ Translator's Note: PATT®—From the German Programmiertes Abkühlen Teilgegarter Teiglinge=Programmed Refrigeration of Partly Fermented Doughs

The starter concentrate can be in paste form (for bakeries that weigh the dough manually) or “liquid” (in the form of a suspension) for bakeries with automatic measuring systems. In both forms—the invention teaches—either at least one yeast component can already be integrated (in the form of “all in one” products), namely with a quantity of yeast such that no additional yeast needs to be added up to the baking process (fill yeast addition), or only a proportional quantity of yeast (e.g., 1/10 to 9/10 of the final amount of yeast). In that case the missing amount of yeast must be added to the starter concentrate before the baking process (partial yeast addition). Finally, the starter concentrate can also be sold without a yeast component.

The freezing point of the paste-form starter product is approximately −5° C. and of the liquid product approximately −3° C. Optimally, the starter concentrate should be stored between 2-7° C. However, since the fermentation continues at a slower rate, the product should be stored, preferably surrounded by a flow of cold air. The starter concentrate is delivered to the end client in an optimal state of fermentation, at a temperate below 6° C., in non-recyclable or recyclable containers with either a plastic insert or in a container. With proper storage, the shelf life is up to 20 days.

Starter concentrates that contain, on the one hand, “processed bran and, on the other hand, malt flour, gluten, amylase enzyme complex and/or water are preferred Ultimately, starter concentrates of this kind relate to one preferred embodiment that includes yeast in the form of compressed yeast (about 29% dry matter (DM)), yeast suspension (20% DM) or dte yeast file obtained during the production of the compressed yeast or a mixture of these. A yeast filtrate may be used in the starter concentrate instead of or in combination with the yeast. Finally, instead of or in combination with the yeast and/or the yeast filtrate, fermentation enzymes, enzyme complexes and enzyme mixtures can be used. For example, one or more, possibly different decarboxylases may be used alone or in combination. These ingredients can release CO₂. The invention teaches that essentially any CO₂-releasing enzyme can be used in the starter concentrate.

Preferred embodiments of starter concentrates taught by the
invention are listed below:
a) Paste-form “dark” starter concentrate for dark dough

| | | minimum | maximum |
|---|---|---|---|
| “Dark” paste | Preferred % | % | % |
| Extruded wheat bran | 30-40, better 35 | 10 | 50 |
| Diastase malt flour | 5-15, better 9.0 | 0 | 20 |
| Wheat gluten | 2-5, better 4.0 | 0 | 10 |
| Ascorbic acid | 0.2-0.5, better 0.4 | 0.1 | 1.0 |
| Enzymes | 0-0.2, better 0.1 | 0 | 0.4 |
| Yeast suspension | 5-20, better 10 | 1 | 50 |
| Yeast filtrate/water | Rest | 0 | 60 |
| Total | 100 | | |

b) Paste-form light starter concentrate for light or dark dough

| | | minimum | maximum |
|---|---|---|---|
| “Light” paste | Preferred % | % | % |
| Extruded hard wheat bran | 30-40, better 35.0 | 10 | 50 |
| Diastase malt flour | 5-15, better 9.0 | 0 | 20 |
| Wheat gluten | 2-5, better 4.0 | 0 | 10 |
| Ascorbic acid | 0.2-0.5, better 0.4 | 0.1 | 1.0 |
| Enzymes | 0-0.2, better 0.1 | 0 | 0.4 |
| Yeast suspension | 5-20, better 10 | 1 | 50 |
| Yeast filtrate/water | Rest | 0 | 60 |
| Total | 100 | | |

c) Paste-form “aleuron-reduced” starter concentrate for
light or dark dough

| | | minimum | maximum |
|---|---|---|---|
| “Aleuron-reduced” paste | Preferred % | % | % |
| Aleuron-reduced wheat | 10-20, better 15 | 4 | 30 |
| bran | | | |
| Diastase malt flour | 20-30, better 25.5 | 0 | 40 |
| Wheat gluten | 6-9, better 7.6 | 0 | 10 |
| Ascorbic acid | 0.2-0.5, better 0.3 | 0.1 | 1.0 |
| Enzymes | 0-0.2, better 0.1 | 0 | 0.4 |
| Yeast suspension | 5-20, better 10 | 1 | 50 |
| Yeast filtrate/water | Rest | 0 | 60 |
| Total | 100 | | |

d) “Dark” starter concentrate suspension for dark doughs

| | | minimum | maximum |
|---|---|---|---|
| “Dark” suspension | Preferred % | % | % |
| Extruded wheat bran | 20-30, better 23.0 | 6 | 33 |
| Diastase malt flour | 5-10, better 6.0 | 0 | 15 |
| Wheat gluten | 2-5, better 2.7 | 0 | 6 |
| Ascorbic acid | 0.1-0.5, better 0.3 | 0.1 | 1.0 |
| Enzymes | 0-0.1, better 0.07 | 0 | 0.3 |
| Yeast suspension | 5-20, better 7 | 1 | 50 |
| Yeast filtrate/water | Rest | 0 | 70 |
| Total | 100 | | |

e) “Light” starter suspension for light and dark doughs

| | | minimum | maximum |
|---|---|---|---|
| “Light” suspension | Preferred % | % | % |
| Extruded hard wheat bran | 20-30, better 23.0 | 6 | 33 |
| Diastase malt flour | 5-10, better 6.0 | 0 | 15 |
| Wheat gluten | 2-5, better 2.7 | 0 | 6 |
| Ascorbic acid | 0.1-0.5, better 0.3 | 0.1 | 1.0 |
| Enzymes | 0-0.2, better 0.07 | 0 | 0.3 |
| Yeast suspension | 5-20, better 7 | 1 | 50 |
| Yeast filtrate/water | Rest | 0 | 70 |
| Total | 100 | | |

f) “Aleuron-reduced” starter concentrate suspension for
light or dark dough

| “Aleuron-reduced” | | minimum | maximum |
|---|---|---|---|
| suspension | Preferred % | % | % |
| Aleuron-reduced bran | 5-15, better 10 | 4 | 30 |
| Diastase malt flour | 5-20, better 16.5 | 0 | 30 |
| Wheat gluten | 4-7, better 5 | 0 | 7 |
| Ascorbic acid | 0.2-0.5, better 0.3 | 0.1 | 1.0 |
| Enzymes | 0-0.2, better 0.1 | 0 | 0.3 |
| Yeast suspension | 5-20, better 7 | 1 | 50 |
| Yeast filtrate/water | Rest | 0 | 70 |
| Total | 100 | | |

In the examples, the yeast preferably has a DM content of 12-28% but more preferably of 15-22% and most preferably 20%. In all of the above mentioned preferred versions the enzyme, ascorbic acid and wheat gluten components can be omitted. The parts by weight that arm thereby lost can be made up by increasing the yeast filtrate/water portion The ascorbic acid component, if and to the extent that it is red in a preferred embodiment, can be replaced by other antioxidant components approved for use in foods (see disclosure in this application). Enzyme-containing natural products, such as honey (in identical minimum/maximum, preferred and more preferred wt. %) may be used as enzymes in the examples described above and below.

g) Other Examples of “dark” starter concentrates

### Example g1

40 parts extruded wheat bran (160° C., particle size less than 315 μm) 10 pats malt flour

<1 part ascorbic acid

<1 part amylase enzyme complex

2.5 parts yeast

50 parts water

The intents used in example g1 constitute a firm paste-form starter concentrate.

### Example g2

40 parts extruded wheat bran (160° C., particle size less than 315 μm)

10 parts malt flour

<1 part ascorbic acid

<1 part amylase enzyme complex

2.5 parts yeast

100 parts water

The ingredients used in example g2 constitute a thick liquid starter concentrate

### Example g3

40 parts extruded wheat bran (160° C., particle size less than 315 μm)

10 parts malt flour

<1 part ascorbic acid

<1 part amylase enzyme complex

30 parts yeast

70 parts water

The intents used in example g3 constitute a paste-form starter concentrate.

### Example 4

40 parts extruded wheat bran (160° C., particle size less than 315 μm)

10 parts malt flour

<1 part ascorbic acid

<1 part amylase m e complex

1 parts yeas

70 parts water

The ingredients used in example g4 constitute a pasty starter concentrate.

Another object of this invention is methods for producing the starter concentrate as taught by the invention whereby (a) food-grade cereal bran, in particular a raw wheat bran, is mechanically, thermally or mechanically-thermally processed, (b) typically water (e.g., filtered water), preferably yeast filtrate/water mixes is added to the “pressed food-grade cereal bran” obtained in (a), and (c) yeast and at least one antioxidant, preferably ascorbic acid, are mixed with the “processed food-grade ceareal bran to which water has been added” according to (b), whereby the consistency varies from a liquid suspension to a solid paste, depending on the amount of water added in (b), and whereby the steps (b) and (c) may alternatively constitute only one procedural step.

In one preferred embodiment of the method taught by the invention, in a step (d) that follows step (c) the fermentation is conducted for up to 72 hours preferably at a decreasing temperature. Furthermore, it is preferable to stop the fermentation at the desired time by lowering the temperature. Typically, the fermentation is essentially inhibited and therefore preferably stopped in a process step (e) by cooling it to 2 to 6° C.

In a particularly preferred procedure, the starter concentrate, after the mixing (process step (c)), in the next process step (d) is allowed to we up to 26 to 32° C., or to a maximum of 36° C., and is then cooled to a paste temperature of approximately 2 to 5° C. within 72 hours.

Starter concentrates that are or can be obtained by the method taught by the invention are an additional object of the invention. With regard to the potential embodiments for each specific method, reference is made to the starter concentrates taught by the invention and to the corresponding disclosure.

An additional object of this invention is the final dough that is produced on the basis of the starter concentrate. For this purpose, the “final dough” means any final dough firm that is subjected to the baling process. The final dough includes the starter concentrate and preferably at least one other ingredient. These one or more additional ingredients are preferably salt, flour, yeast and/or water. A technician skilled in the art will make partly or wholly yeast-raised baked goods, in particular bread-like baked goods and pizza, from the final dough, which may be given a resting period. Baked goods of this type produced from the final dough taught by the invention are an additional object of this invention.

Likewise, methods for producing partly or wholly yeast-raised baked goods, especially bread and pizza, are an additional object of tis patent application. For this purpose, (a) first a starter concentrate is produced as t by the invention, then (b) products, salt, flour, yeast and=or water, for example, are added to the starter concentrate obtained according to (a) to form a final dough, (c) the dough is processed in a dough-making system, preferably as in the direct rise process, and finally, (d) subjected to a baking process. The baking process may be carried out in an oven, whereby the baking temperature and duration will depend on the type and size of the goods being baked. For example, at least 40 minutes at temperatures of more than 200° C. are preferred for the white bread according to the invention Fundamentally, the baking temperature for the production of the baked goods should be above 100° C. and the duration of baking should be at least 5 min.

In one preferred embodiment this method is realized so that the proportion of the starter concentrate will be between 1 and 6 parts by weight, preferably between 2 and 3 parts by weight, of te total quantity of final dough.

Methods for producing the basic starter and the basic starter are an additional object of this invention The method for producing the basic starter is characterized by (a) a raw food-grade cereal bran, in particular crude wheat bran, which is mechanically, themally or mechanically-thermally processed, (b) typically water and preferably a yeast fi ta mixture that is added to and mixed into the “pissed food-grade cereal bran” obtained in (a), and (c) the “processed food-grade cereal bran with water added” is stored under aerobic conditions for at least 12 hours. Typically, the storage will be for several days to permit the product to take up airborne wild yeast. Preferred storage periods are more than 15 days. In the course of adding the aqueous components, other food adjuvants, additives and supplements (e.g., the substances disclosed in this invention (e.g., vitamins, minerals etc.)) can be added The invention also teaches a basic starter that is or can be obtained according to a method as taught by the invention (analogous to the method of manufacturing a starter from a “mother”), see also alternative (ii) on p. 9 and Example 4 of this disclosure. This basic starter can be used as the basis for the starter concentrate.

Finally, a procedure for producing the starter concentrate is an additional object of this invention It is characterized by the steps (a) to (c) (see above) of the method for producing the basic starter, and in a step (d) the basic starter obtained in step (c) is then mixed with the mechanically, thermally or mechanically-thermally modified raw food-grade cereal bran (“processed food-grade cereal bran”). Optionally, in an additional step (e), water, preferably a yeast filtrate/water mixture, is added in another step. Optionally, steps (d) and (e) can be combined into one step. Therefore, the starter concentrate that is or can be obtained by a method taught by the invention is an additional object of this invention.

The invention teaches the use of a starter concentrate as claimed in one of the claims 1 to 15 and 20 or 30, a final dough as claimed in claims 21 or 22 and a basic starter as claimed in claim 28 for producing yeast-raised baked goods, especially bread-like baked goods and pizza.

This invention is explained in greater detail below on the basis of the following exemplary embodiments.

### EXAMPLES OF VERSIONS

Produced of Preferred Embodiments of the Starter Concentrate

(A)

The starter concentrate taught by the invention is a natural bread improvement agent that is added to the main dough and is finally subjected to a baling process. The starter includes the above-mentioned mechanically, thermally or mechanically-thermally modified “processed bran to which water has been added” as the base, optionally with other adjuvants and additives such as yeast and ascorbic acid. In case of the optional addition of malted grain, preferably in the form of malt flour, wheat gluten, enzymes and water, a starter concentrate as taught by the invention was made available by mixing the malted grain components into a paste as taught by the invention After this mixing process the paste had an average temperature between 16 and 20° C., and rises as a result of the metabolic processes of the optionally added yeast. If yeast was added or contained in the past, rapid cooling prevents the temperate of the mixture from rising above approximately 32° C. After continuous cooling the paste had a temperature of −2 to 4 or 5° C. after 24 -72 hours.

Examples of cooling:

| | Example 1 | Example [1]2 |
|---|---|---|
| Start | 16-20° C. | 16-20° C. |
| 3 hours | 27-30° C. | 29-32° C. |
| 6 hours | 24-26° C. | 26-28° C. |
| 9 hours | 19-21° C. | 24-26° C. |
| 12 hours | 16-18° C. | 21-23° C. |
| 18 hours | 11-13° C. | 16-18° C. |
| 24 hours | 8-10° C. | 11-13° C. |
| 30 hours | 6-8° C. | 8-10° C. |
| 36 hours | 5-7° C. | 6-8° C. |
| 42 hours | 4-6° C. | 4-7° C. |
| 48 hours | 2-4° C. | 2-5° C. |

Depending on the mount of water added, the starter concentrate may be made available in the form of a paste or a liquid product (suspension). To prepare the starter concentrate in the form of a suspension, ice water is added with gentle agitation after the cooling process until the desired viscosity is achieved. The pumpable solution is then packaged and stored as already described.

The starter concentrate can be feted using normal compressed yeast, yeast suspension, the filtrate accumulated during compressed yeast production or a mixture of those substances. The use of artificial acids, such as acetic or lactic acid, and ser cultures can optionally be omitted.

B)

(1) Preferably the “dark” starter concentrate taught by the invention for dark dough includes:

mechanically and/or thermally processed crude food-grade cereal bran, in particular extruded (140-180° C., preferably 160° C.; moisture 6 to 8, preferably approximately 7% by volume; ash 5 to 8 (DM, preferably approximately 6% by volume; particle size/granulation: particle size preferably less than 400 μm more preferably 350 tun and even more preferably less than 315 μm (over 99%), preferably 95%<200 μm, 73%<125 μm, 54%<90 μm, 22%<63 μm), raw bran, also preferably, for example, “processed wheat bran” or mixtures of extruded “processed wheat bran” and extruded “processed hard wheat in” (140-180° C., preferably 160° C.; particle size less than 315 μm, preferably 82%<200 μm,55%<125 μm, 39%<90 μm, 21>63 μm),

Malted grin products or components of malted grain products, preferably malt flour,

At least one antioxidant ingredient, for example, ascorbic acid,

Optionally wheat gluten,

Yeast; whereby the yeast includes compressed yeast (approximately 28% dry matter (DM) and/or yeast suspension (20% DM) and preferably also the irate obtained during compressed yeast production,

Enzymes, preferably final α-amylase with secondary activities,

Water.

(2) Preferably the “light” Dater concentrate taught by the invention for light or dark dough includes:

mechanically and/or thermally “processed food-grade cereal bran”, in particular extruded processed hard wheat bran (moisture >5% by volume, ash 4 to 8 (DM), preferably approximately 5% by volume; particle size/granulation: particle size preferably less than 400 μm, but more preferably less than 350 μm and even more preferably less than 315 μm (over 99%), preferably 82%<200 μm, 55%<125 μm, 39%<90 μm, 21>63 μm).

Malted grain products, or one or more components of malted grain product, but preferably malt flour,

At least one antioxidant component, for example, ascorbic acid,

Optionally wheat gluten,

Yeast; whereby the yeast includes compressed yeast (about 28% dry mater (DM) and/or a yeast suspension (20% DM) and preferably also the filtrate obtained during compressed at production,

Enzymes, preferably fungal α-amylase with secondary activities,

Water.

(3) Preferably, the “aleuron reduced” starter concentrate taught by the invention for light or dark dough includes:

Aleuron-reduced food-grade cereal bran, in particular wheat bran (granulation/particle i: particle size preferably less than 400 μm, but preferably less than 350 μm and even more preferably less than 315 μm (over 99%), preferably between 60μm to 125 μm, and particular preferably 75 μm),

Malted products or one or more components of malted grain products, preferably malt flour,

At least one antioxidant component, for example, ascorbic acid,

Optionally wheat gluten,

Yeast; whereby the yeast includes compressed t (about 28% dry matter (DM) and/or yeast suspension (20% DM) and preferably also the filtrate obtained during compressed yeast production,

Enzymes, preferably fungal α-amylase with secondary activities,

Water.

To produce the preferred versions of the starter concentrates as taught by the invention, the dry substances are typically weighed together and mixed. Then the liquids are added at an initial temperature of approximately +3° C. and mixed into a paste with the dry substances. The freshly produced paste at an initial temperature of approximately 16 to 20° C. immediately begs to ferment and the heat of fermentation rapidly elevates the temperature to between 26 and 32° C. To avoid overheating (particularly over 36° C.) that may result in the formation of acetic acid, the cooling must be initiated as quickly as possible. In a batch process, stirring or processing of the paste during fermentation should be avoided so that no additional oxygen is introduced and, therefore, anaerobic conditions in the paste are guaranteed In an anaerobic milieu the yeast will create the desired precursors of the aromatic compounds. In a continuous method, the processing should be as gentle as possible.

When the paste was subsequently portioned out in synthetic meshes (40×60 cm), as used in yeast production, and was cooled in a location with a strong cold air flow of approximately 0° C., a paste temperature of about 2-5° C. was achieved in about 24 to 72 hours. This temperature was sufficient to reduce the fermentation process to a rum. Reference is made to above examples that illustrate the cooling process

(4) Production of a starter concentrate based on extruded wheat bran and water.

In this exemplary embodiment, a starter concentrate was prepared based on extruded wheat bran in the form of P ed bran” and water, i.e., without a defined yeast addition (see alterative (ii) on p. 9 of this disclosure). For this purpose, first step (1) is conducted, analogous to the production of a basic “mother” dough, then in step (2), the product of(1) is processed analogous to a “mother” dough and finally in step (3) the starter concentrate taught by the invention is produced on th basis of extruded “processed bran,” “mother” basic dough and water.

Step 1

Production of a basic starter

The following conventional conditions were selected in a 10-stage process analogous to the production of a basic “mother” dough:

In a production process over 10 stages (repetition over 10 sequential days using a basic amount of the previous day's dough), (i) the extruded bran and water were stirred into a dough and fermented for about 6 hours at approximately 32° C., then (ii) the dough obtained in (i) was immediately cooled to +2 to +6° C. and then stored for 18 hours cooled (preferably over night). Finally, the dough was refreshed daily following this pattern for the next day. For keeping over weekends and holidays the dough was stored at -2 to at most +2° C.

Recipe with extruded bran

| | Dough | | | |
|---|---|---|---|---|
| | (previous day) | Bran | Water | Total dough |
| 1^{st} stage | | 100 | 200 | 300 |
| 2^{nd} stage | 150 | 50 | 100 | 300 |
| 3^{rd} stage | 150 | 50 | 100 | 300 |
| 4^{th} stage | 150 | 50 | 100 | 300 |
| 5^{th} stage | 150 | 50 | 100 | 300 |
| 6^{th} stage | 150 | 50 | 100 | 300 |
| 7^{th} stage | 150 | 50 | 100 | 300 |
| 8^{th} stage | 150 | 50 | 100 | 300 |
| 9^{th} stage | 150 | 50 | 100 | 300 |
| 10^{th} stage | 150 | 50 | 100 | 300 |

Step 2

Propagation of the basic starts:

The basic starter was propagated in an about 6-hour fermentation at about 32° C. This was done by 2/3 (bran+water)+1/3 basic starter (from the previous day) and fermenting it over about 6 hours at about 32° C. The processes followed the same pattern on subsequent days.

Step 3

Production of the starter concentrate

Finally, the increased basic starter obtained in Step 2 was mixed or combined with the “processed bran” and water. In specific cases the weight ratios in the combination of these three components may vary, typically depending on the desired dough viscosity. Typically, about 28 to 35 parts by weight basic starter, 27 to 34 parts by weight “processed bran” and 33 to 40 parts by weight water are combined. A preferred recipe for the starter concentrate has about 33 wt. % basic starter, about 33 wt. % “processed bran” and about 37 wt. % water.

The starter concentrate (obtained or obtainable from the above procedure according to example 4) fermented with a separately produced basic starter (“mother”) does not differ in appearance and in use (dough consistency, volume, sensory properties, freshness etc.) from starter concentrates with specific amounts of conventional yeast added (see examples 1-3). Otherwise, all adjuvants, supplements and additives cited in this disclosure can essentially be added to starter concentrates or produced according to Example 4. Further additives, such as malt flour, antioxidants, gluten etc. have the same function in both starter concentrates. In particular, they function to compensate for varying flour qualities, production processes and recipes.

In conclusion, it can be noted that high quality baked goods can be produced with the starter concentrate taught by the invention, which consists only of modified, for example, extruded “processed bran” and water, using the fermentation processes described above (in a type of “mother” production). These baked goods have good aroma and taste, good mouth feel and keep fresh for longer periods. Depending on the recipe, flour quality, requirements for production safety and the use of other dough-making systems, such as interrupted fermentation (by cooling the doughs), delayed fermentation (by refrigerating the doughs), PATT (programmed refrigeration of partly fermented doughs, from Kolb-Kältetechnik A G, C H), etc., other ingredients s as wheat gluten, malt flour, enzymes and antioxidants can further enhance product quality.

Production of baked goods based on starter concentrates taught by the invention

The invention teaches that baked goods produced using t starter concentrate taught by the invention have outstanding qualities in terms of dough development, dough stability and volume.

Using light wheat flour (Flour Type 700) and the light starter concentrate broadly based and baking trials were conducted. The results have been summarized below:

| | | | | | Baking test | |
|---|---|---|---|---|---|---|
| | Rising test | | | | | Volume |
| | Max. dough | | Total CO₂ | | Ideal unit | from 100 g |
| | development | | generation | Gas retention | ferm. | flour |
| PRODUCT* | Min. | ml | ml | Min. | Min. | ml |
| 0 trial | 105 | 300 | 569 | 105 | 45 | 531 |
| 2% starter | 90 | 270 | 619 | 90 | 45 | 510 |
| light | | | | | | |
| 4% starter | 92 | 270 | 596 | 90 | 45 | 498 |
| light | | | | | | |
| 6% starter | 135 | 270 | 629 | 75 | 45 | 498 |
| light | | | | | | |
| 8% starter | 120 | 280 | 612 | 75 | 45 | 464 |
| light | | | | | | |

| | | | 4% light starter | | 8% light starter | |
|---|---|---|---|---|---|---|
| | 0-test | | concentrate | | concentrate | |
| | Dough | CO₂ | Dough | CO₂ | Dough | CO₂ |
| Time* | development | production | development | production | development | production |
| (min.) | ml | ml | ml | ml | ml | ml |
| 0 | 0 | 0 | 0 | 0 | 0 | 0 |
| 15 | 20 | 14 | 40 | 25 | 40 | 21 |
| 30 | 60 | 50 | 90 | 63 | 100 | 75 |
| 45 | 120 | 97 | 140 | 102 | 160 | 123 |
| 60 | 160 | 135 | 190 | 160 | 200 | 164 |
| 75 | 200 | 173 | 240 | 205 | 240 | 222 |
| 90 | 250 | 231 | 270 | 250 | 240 | 269 |
| 105 | 300 | 283 | 240 | 313 | 260 | 314 |
| 120 | 280 | 328 | 280 | 362 | 280 | 388 |
| 135 | 230 | 391 | 280 | 408 | 270 | 450 |
| 150 | 260 | 443 | 300 | 487 | 290 | 492 |
| 165 | 300 | 492 | 320 | 551 | 290 | 554 |
| 180 | 260 | 569 | 300 | 596 | 310 | 612 |

*Dosing of starter concentrate relative to the total amount of flour

The results confirm that dough that was produced with the starter concentrate not only exhibits rapid development but also remains stable fr a much longer period

Preferred extrudates:

1) As already stated, the extruded wheat bran that is preferably used for the “dark” concentrate has the following particle size distribution in a sieve analysis (moisture 7.3% by weight, ash (DM) 5.95% by weight):

| | |
|---|---|
| Retained at 315 μm | 0.7% by weight |
| Retained at 200 μm | 4.8% by weight |
| Retained at 125 μm | 27.1% by weight |
| Retained at 90 μm | 46.1% by weight |
| Retained at 63 μm | 78.4% by weight |

2) Extruded hard wheat bran or aleuron-reduced wheat bran is advantageously used for the starter concentrate in “light” dough. A preferred “aleuron-reduced” wheat bran has the following particle size distribution:

| | |
|---|---|
| Retained at 315 μm | 0.9% by weight |
| Retained at 200 μm | 2.6% by weight |
| Retained at 125 μm | 12.7% by weight |
| Retained at 90 μm | 47.3% by weight |
| Retained at 63 μm | 81.6% by weight |

3) Extruded hard wheat exhibits in a sieve analysis (moisture 4.5% by weight, ash (DM) 5.10% by weight) the following particle distribution:

| | |
|---|---|
| Retained at 315 μm | 0.6% by weight |
| Retained at 200 μm | 17.9% by weight |
| Retained at 125 μm | 45.1% by weight |
| Retained at 90 μm | 60.7% by weight |
| Retained at 63 μm | 78.9% by weight |

Processing from starter concentrates taught by the invention into baked goods

The starter concentrate offers significant advantages for processing in bakery operations because, unlike conventional starters, it is added directly to the main dough. It was found in trials that the amount of yeast required is less than the amount required in conventional direct dough-making with baking additives. Furthermore, the dough could be processed significantly more rapidly than when using baking additives and starters, which result in timesavigns during production. The amount of water added could be increased, i.e., the dough yield was greats. In particular, the starter concentrate taught by the invention is advantageous compared to the starter of the prior art because the prior-art starter results in a significantly lower dough yield. The dough yield of the starter concentrate is better than the dough yield obtained with conventional baking additives.

Apart from the desirable properties described above, the starter concentrate is characterized by an acceleration of dough development, an opt on of the processing qualities of the dough and enhancement of the sensory qualities of the baked goods. This is particularly evident in an improved and stronger aroma and taste, pleasant mouth feel, a shorter and crumblier crust and crumb and longer lasting freshness of the products.

The starter concentrate taught by the invention can, as stated, also be sold in the form of an all-in-one product, i.e., in one embodiment it may already contain the yeast required for making the final dough so that it does not require the addition of yeast At the bakery, only flour, water and salt need to be added to the all-in-one dough to produce the main (final) dough and to initiate the baking process

Some brief recipes are presented below for using the starter concentrate m the production of typical baked goods. As noted above, the concentrate can be used with the customary adaptations of recipes to produce a broad range of baked goods.

| | | | | | Ticino-style | |
|---|---|---|---|---|---|---|
| | | | | | bread | |
| | Dark rustic | Light wheat | Butter-top | Parisian- | (Tessiner | |
| | bread | bread | braid | style bread | Brot) | Buns |
| Ingredients | in % | in % | in % | in % | in % | in % |
| White flour | x | x | 100.0 | 100.0 | 100.0 | 100.0 |
| type 400 | | | | | | |
| Light wheat | x | 100.0 | x | x | x | x |
| flour | | | | | | |
| Swiss | 100.0 | x | x | x | x | x |
| country | | | | | | |
| bread-type | | | | | | |
| flour | | | | | | |
| Water | 70.0-72.0 | 67.5-69.5 | 49.0-51.0 | 61.0-63.0 | 55.0-57.0 | 57.0-59.0 |
| Cooking salt | 2.2-2.5 | 2.2-2.4 | 1.9-2.2 | 2.1-2.3 | 2.0-2.2 | 2.1-2.3 |
| Yeast | 1.3-1.6 | 1.3-1.6 | 1.9-2.2 | 3.2-3.5 | 3.0-3.2 | 3.2-3.4 |
| Light paste | x | 4.0 | 5.0-6.0 | 5.0-6.0 | 4.0-5.0 | 5.0-6.0 |
| Dark paste | 4.0 | x | x | x | x | x |
| Baker's | x | x | x | x | x | 0.8-1.2 |
| margarine | | | | | | |
| Special oil | x | x | x | x | 5.0-5.2 | x |
| Special | x | x | 4.0-5.0 | x | x | x |
| powdered | | | | | | |
| milk | | | | | | |
| Cooking | x | x | 12.0-14.0 | x | x | x |
| butter | | | | | | |
| Whole egg | x | x | 2.3-2.6 | x | x | x |
| (pasteurized) | | | | | | |

Depending on the type of flour, the wheat or hard wheat bran in the above-described starter concentrates can be supplemented or replaced in whole or in part by other types of food-grade cereal bran to be processed, such as spelt, emmer, einkorn, rye, oats, barley, millet, corn and/or rice bran Ideally the modified “processed bran” in the starter concentrate is selected so that the end product is optimized in terms of baking technology and taste.

Since rye flour has no gluten, it must be prepared for baking by souring. This can be achieved by the conventional multi-stage process or by adding acid or strongly acidic baking additives. The new starter concentrate is not an acidification agent and therefore is only suited for rye bread when the known means of acidification are used.

Therefore, the invention teaches that baked goods that are made using the starter concentrate taught by the invention have outstanding qualities regarding the preservation of freshness, regardless of the production route. Thus, bread remains fresh for up to 36 hours, which has incalculable logistical advantages for centralized production with longer delivery routes.

1. A starter concentrate, in particular for producing partly or wholly yeast-raised baked goods, comprising: mechanically, thermally or mechanically-thermally modified food-grade cereal bran (“processed food-grade bran”), preferably with the addition of water, optionally yeast and optionally at least one antioxidant.

2. Starter concentrate as claimed in claim 1, characterized by the fact that the starter concentrate comprises ascorbic acid and/or a solution containing ascorbic acid as the antioxidant

3. Starter concentrate as claimed in claims 1 and 2, characterized by the fact that the “process food grade cereal bran” is preferably extruded.

4. Starter concentrate as claimed in one of the preceding claim characterized by the. fact that the “modified processed food-grade cereal bran” consists of wheat or hard wheat bran or mixture thereof.

5. Starter concentrate as claimed in one of the preceding clam characterized by the fact that the modified “processed food-grade cereal bran” is extruded at 130-180° C., preferably at 150° C.

6. Starter concentrate according to claims 4 or 5, characterized by the fact that the modified wheat bran has particle sizes less than 315 μm preferably with a particle size distribution of at least 95%<200 μm, at least 73%<125 μm, at least 54%<90 μm and at least 22%<63 μm, for use in making dark doughs.

7. Starter concentrate as claimed in claims 4 or 5, characterized by the fact that the modified hard wheat bran has particle sizes less than 315 μm, preferably with a particle size distribution of at least 82%<200 μm, alt least 55%<125 μm, at least 39%<90 μm and at least 21%<63 μm, for use in making light or dark doughs.

8. Starter concentrate as claimed in claims 4 or 5, characterized by the fact that the modified hard wheat bran has particle sizes less than 315 μm, preferably with a particle size distribution of at least 72%<200 μm, at least 45%<125 μm, at least 29%<90 μm and at least 11%<63 μm, for use in making light or dak doughs.

9. Starter concentrate as claimed in one of the preceding claims, character by the act that the share by weight of the modified processed food-grade cereal brans in the starter concentrates 6 to 50%, preferably 20 to 40% and even more preferably 30 to 40% for a paste-form starter concentrate and 20 to 25% for a starter concentrate suspension.

10. Starter concentrate as claimed in claim 9, characterized by the fact that the percentage by weight of the modified “processed food-grade cereal bran” in the starter concentrate is 35% for a paste-form starter concentrate and 23% for a starter concentrate suspension.

11. Starter concentrate as claimed in one of the preceding claims, characterized by the fact that the modified “processed food-grade cereal bran” is a residual bran that has a reduced proportion of aleuron or is aleuron-free.

12. Starter concentrate as claimed in claim 11, characterized by the fact that the share by weight of the modified “processed food-grade cereal bran” is 4 to 30%, preferably 10 to 20% for a paste-form starter concentrate and 5 to 15% for a starter concentrate suspension.

13. Starter concentrate as claimed in claim 12, characterized by the fact that the share by weight of the modified food-grade cereal bran in the starter concentrate is 15% for a paste-form starter concentrate and 10% for a starter concentrate suspension.

14. Starter concentrate as claimed in one of the preceding claims, characterized by the fact that it includes malt flour, gluten, amylase enzyme complex and/or water.

15. Starter concentrate as claimed in one of the preceding claims, characterized by the fact that the starter concentrate includes, as the yeast, compressed yeast (approximately 29% dry matter (DM)) or a yeast suspension (20% DM) or the filtrate obtained during the production of compressed yeast or a mixture thereof.

16. Method for producing a starter concentrate as claimed in one of the preceding claims, characterized by
(a) raw food-grade cereal bran, in particular raw wheat bran, that is m mechanically, thermally or mechanically-thermally posed,
(b) typically water, preferably a yeast filtrate/water mixture, that is added to the processed food-grade cereal bran obtained according to (a).
(c) yeast and at least one antioxidant, preferably ascorbic acid, that is combined with the “processed food-grade cereal bran to which water has been added” according to (b), whereby the consistency can range from a liquid suspension to a firm paste, depending on the proportion of water added m (b) and whereby steps (b) and (c) can alternatively represent only one step.

17. Method as claimed in claim 16, characterized by the fact that after step (c), fermentation takes place in a step (d) for up to 72 hours, preferably at a decreasing temperature.

18. Method as claimed in claim 17, characterized by the fact that the fermentation is essentially stopped by cooling to between 2 and 6° C. in a step (e).

19. Method as claimed in claims 16 or 17, characterized by the fact th after the Egg the starter concentrate is allowed to heat up to 26 to 32° C., with a maximum of 36° C., and is then cooled within 72 hours to between 2 and 5° C.

20. Starter concentrate, characterized by the fact that it can be obtained by a method as claimed in one of the claims 16, to 19.

21. Final dough, characterized by the fact that it includes a starter concentrate as claimed in one of the claims 1 to 15 or 20, as well as preferably at least one additional ingredient.

22. Final dough as claimed in claim 21, characterized by the fact that it includes salt, flour and/or water as additional ingredients.

23. Wholly or partly yeast-raised baked goods, in particular bread-like baked goods and pi char by the fact that they are manufactured from a final dough as claimed in claims 21 or 22.

24. Method for the production of wholly or partly east-raised baked goods, in particular bread-like baked goods and pi characterized by the fact that
(a) a starter concentrate is produced according to a method as claimed in one of claims 16 to 19
(b) the starter concentrate obtained according to (a) is combined with grain product, salt, flour and/or water to form a final dough,
(c) the dough is processed in a dough-making system, preferably using a direct dough, and
(d) is finally subjected to a baking process.

25. Method as claimed in claim 24, characterized by the fact that the proportion of starter concentrate in the amount of dough is between 1 and 6 parts by weight, preferably between 2 and 3 parts by weight.

26. Use of a starter concentrate as claimed in one of the claims 1 to 15 or 20 for producing a final dough or wholly or partly yeast-raised baked go in particular pizza or baked goods.

27. Method for producing a basic starter, characterized by the fact that
(a) Raw food-g cereal bran, in particular crude wheat bran, is pros by mechanical thermal, thermal-pneumatic or mechanical-thermal means,
(b) Typically water, preferably a yeast filtrate/water mixture, is added to the “processed food-grade cereal bran” obtained in (a),
(c) The “processed food-grade cereal bran” to which water has been added obtained in (b) is stored for at least 12 hours under aerobic conditions.

28. Basic starter obtained by a method as claimed in claim 27.

29. Method for producing a starter concentrate, characterized by he fact that the steps (a) to (c) claimed in claim 27 being performed,
(a) the basic starter obtained according to step c) is mixed with mechanically, thermally or mechanically-thermally modified crude food-grade cereal bran (“processed food-grade cereal bran”), and
(b) water, preferably a yeast filtrate/water mixture, is added.

30. Starter concentrate obtained according to a method as claimed in claim 29.

31. Use of the basic starter as claimed in claim 28 or a starter concentrates claimed in claim 30 for producing yeast-raised baked goods, in particular bread-like baked or pizza.
